(19) United States
(12) Patent Application Publication
(10) Pub. No.: US 2009/0167530 A1
(43) Pub. Date: Jul. 2, 2009

(54) REMOTE PUBLIC FULL-TIME ANTI-THEFT SYSTEM

(75) Inventor: Lei SONG, Beijing (CN)

Correspondence Address: YING CHEN;Chen Yoshimura LLP, 255 S. GRAND AVE., # 215, LOS ANGELES, CA, 90012, US

(73) Assignee: BEIJING RUTIAN SCIENCE AND TECHNOLOGY CO., LTD, Beijing (CN)

(21) Appl. No.: 12/112,300

(22) Filed: Apr. 30, 2008

(30) Foreign Application Priority Data
Dec. 29, 2007 (CN) 200710304724.5

(51) Int. Cl. G08B 13/14

(52) U.S. Cl. 340/571

(57) ABSTRACT

The invention relates to a remote anti-theft alarm system comprising a plurality of mechanical switches for collecting moving signals of protected objects, a plurality of self-induced infrared sensors for collecting signals of relative movements between protected objects and adjacent objects and a spot detecting-and-alarming circuit, wherein the mechanical switches and the self-induced infrared sensors connect in the spot detecting-and-alarming circuit which communicates with a remote supervision center through a public data communication network. This system is excellent in anti-theft effects and difficult to be damaged by a thief, especially suitable for anti-theft of valuables in public.

### BACKGROUND OF THE INVENTION

1. Field of the Invention

The invention relates to a remote anti-theft alarm system, which is especially suitable for anti-theft of bulky valuables placed in public places.

2. Description of the Related Art

Market places, exhibition buildings, outdoor exhibition venues, meeting rooms and other public places usually have some bulky valuables, which are more likely to suffer theft in an unattended condition. In order to prevent theft, people usually fix these valuables on land by certain connecting modes to prevent them from being taken away by a thief. Such mechanically fixed modes realize anti-theft in some degree, but bring inconvenience to people for it will be very troublesome to move them. In the other hand, such protection can only work when there are many people during daytimes. In such unattended conditions at night, no matter how firm the installation is, these valuables can be removed away. Therefore, the safeguard work needs to be strengthened during nights, consuming a lot of manpower and material resources. People also try to take advantage of an electronic anti-theft system in the preventing of theft. A widely used method of electronic anti-theft system is to set up an infrared sensor to supervise the intrusion of a thief. However, the defending measure can be easily impacted by surrounding environment in that there are many people in the public place. It should be ensured that nobody enters the defended area, so people cannot watch a defended article closely. Otherwise, false alarms will be produced in some time, which seriously dampens the due effects of defended articles in public.

### SUMMARY OF THE INVENTION

To overcome the present technical deficiencies, this invention offers a remote public full-time anti-theft system, which is excellent in anti-theft effects and easy in deployment. This system is difficult to be damaged by a thief and has no unfavorable effects people's views. Therefore, this system is especially suitable for anti-theft of valuables in public, particularly for bulky and heavy valuables and other objects.

The technical solution of the present invention to achieve above purposes is: a remote public full-time anti-theft system, comprising a plurality of mechanical switches for detecting moving signals of protected objects, a plurality of self-induced infrared sensors for detecting signals of relative movements between protected objects and adjacent objects and a spot detecting-and-alarming circuit, wherein the output terminals of the mechanical switches and the self-induced infrared sensors are connected to a spot detecting-and-alarming circuit, which communicates with a remote supervisory and controlling equipment through a public data communication network.

Owing to that the anti-theft detecting elements of this system are mechanical switches and self-induced infrared sensors, these switches can be installed in or directly contact a object to be protected, these sensors can be arranged in or near the object to be protected. This system will not be affected by surroundings whether there are people or not. So, this system neither obstructs people to approach to the protected objects nor produces false alarm when there are people around. Moreover, when the protected object is be moved, the statuses of the mechanical switches and the sensors will change accordingly, making a change in the spot detecting-and-alarming circuit change and result in alarming signals made by the spot detecting-and-alarming circuit. Related persons can learn the signals by means of the remote supervisory and controlling equipment and take measures to prevent theft.

Advantageous effects of this system are embodied in that: (1) Owing to that the mechanical switches and the self-induced infrared sensors in the signal pickup circuit turn on or off in line with mechanical the statuses of deployed equipments, and the deployment only aims at the equipment, thus whether there are people around the equipment or not, this anti-theft and alarming system can not be affect. Therefore, this system can realize a long-time, continuous and full-time protection and supervision and is free from false alarms due to the presence of animals or other circumstances around; (2) When the protected objects are on normal conditions and need not move, neither a repeal of deployment nor a redeployment is required at any time, and thereby, work loaded on related personnel will be greatly reduced; (3) Based on characteristics of the deployed equipment, when a theft occurs, there must be a change in mechanical status of the deployed equipment, triggering the system to alarm; moreover, the switches and the self-induced infrared sensors can be arranged in the shadows of or even inside the deployed equipment so that a thief has to change the mechanical status of the deployed equipment and trigger alarm prior to damaging these switches and sensors; (4) The switches used in this system have a much simpler structure and a much lower cost than that of infrared transceiver elements used in prior technology.

### BRIEF DESCRIPTION OF THE DRAWINGS

FIG. 1 is a structural scheme of a remote public full-time anti-theft system.

### DETAILED DESCRIPTION OF THE PREFERRED EMBODIMENTS

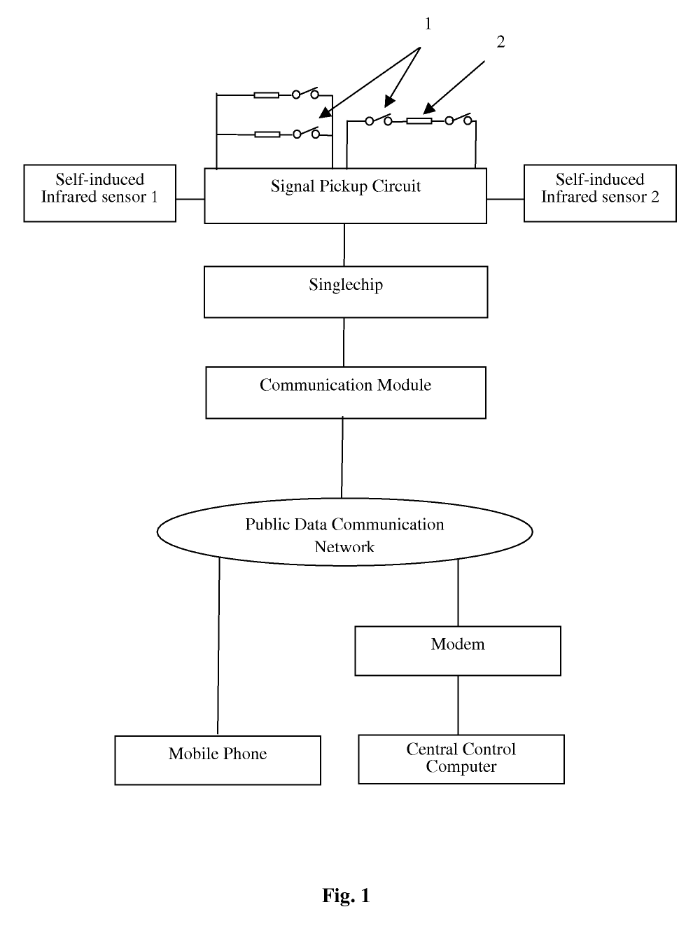

With reference to FIG. 1, this system comprises a plurality of mechanical switches 1, a plurality of self-induced infrared sensors, a signal pickup circuit, a singlechip and a communication module. The signal pickup circuit, the singlechip and the communication module constitute the spot detecting-and-alarming circuit. Wherein, the mechanical switches and the self-induced infrared sensors are connected in parallel with each other in the signal pickup circuit, the signal pickup circuit is connected to the singlechip. The singlechip is connected to the communication module through its serial port and communicates with a supervision center through a public data communication network. Wherein, the supervision center consists of a modem and a central control computer. The central control computer is connected with the public data communication network through the modem. The mobile phone communicates with the communication module directly through the public data communication network.

A the mechanical switch is such an electric break as a point-of-contact mechanical switch, a travel mechanical switch, a micro-active mechanical switch, a shorting-stub, a draw-out mechanical switch, a mercury mechanical switch and a door magnetic mechanical switch.

The mechanical switches can be connected with each other either in series or in parallel. In series connection, all mechanical switches usually hold an “on” status in the alarm position. The signal pickup circuit cuts off when any of the mechanical switches turns from “on” to “off”. The conversion of the signal pickup circuit from cut-off to conduction makes a signal output to the communication module.

When in parallel connection, the mechanical switches usually hold an “off” status and the signal pickup circuit cut off. When any one of the mechanical switches turns from “off” to “on”, the signal pickup circuit conducts. The conversion of the signal pickup circuit from cut-off to conduction makes a signal output to the communication module.

In order to guarantee the security of the alarming system, the series connection of mechanical switches is usually adopted.

The self-induced infrared sensors sense relative movements between the protected objects and its adjacent objects. These sensors do not radiate to the surrounding environment and thereby has no effects to people around.

For example, in order to protect a transformer in outside, the mechanical switches can usually be installed into the cover plate of the transformer for sensing the move of the cover plate. When the cover moves, the status of the mechanical switches enables a signal producing element at an input end of the signal pickup circuit to send out signals. The signals are converted by an analog-digital circuit into digital signals, which are processed and converted by the singlechip in line with the formats of wireless communication protocols and then, transmitted by the communication module to computers of the supervision center and mobile phones of related personnel through the public data communication network.

The communication module can be a GSM communication module, a GPRS communication module or a CDMA communication module. The public data communication network can be a GSM wireless data communication network, a GPRS wireless data communication network or a CDMA wireless data communication network. The communication module is a wireless data-transmitting module or a wireless transmitter.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A remote public full-time anti-theft system, comprising:
a plurality of mechanical switches for detecting moving signals of protected objects;
a plurality of self-induced infrared sensors for detecting signals of relative movements between the protected objects and adjacent objects; and
a spot detecting-and-alarming circuit,
wherein the mechanical switches and the self-induced infrared sensors are connected to the spot detecting-and-alarming circuit which communicates with a remote supervision center through a public data communication network.

2. The remote public full-time anti-theft system as described in claim 1, wherein the spot detecting-and-alarming circuit includes a signal pickup circuit, a singlechip and a communication module.

3. The remote public full-time anti-theft system as described in claim 2, wherein the supervision center includes one or more mobile phones and one or more central control computers, each central control computer including a modem.

4. The remote public full-time anti-theft system as described in claim 2, wherein the mechanical switches are connected with each other either in series or in parallel and then connected to the signal pickup circuit.

5. The remote public full-time anti-theft system as described in claim 4, wherein signal pickup circuit is connected to the singlechip, and wherein the singlechip is connected to the communication module through a serial port.

6. The remote public full-time anti-theft system as described in claim 5, wherein the mechanical switches are point-of-contact mechanical switches, travel mechanical switches, micro-active mechanical switches, shorting-stubs, draw-out mechanical switches, mercury mechanical switches or door magnetic mechanical switches.

7. The remote public full-time anti-theft system as described in claim 6, wherein the communication module is a wireless data-transmitting module or a wireless transmitter.

8. The remote public full-time anti-theft system as described in claim 7, wherein the communication module is a GSM communication module, a GPRS communication module or a CDMA communication module.

9. The remote public full-time anti-theft system as described in claim 8, wherein the public data communication network is a GSM wireless data communication network, a GPRS wireless data communication network or a CDMA wireless data communication network.

10. The remote public full-time anti-theft system as described in claim 3, wherein the mechanical switches are connected with each other either in series or in parallel and then connected to the signal pickup circuit.

11. The remote public full-time anti-theft system as described in claim 10, wherein signal pickup circuit is connected to the singlechip, and wherein the singlechip is connected to the communication module through a serial port.

12. The remote public full-time anti-theft system as described in claim 11, wherein the mechanical switches are point-of-contact mechanical switches, travel mechanical switches, micro-active mechanical switches, shorting-stubs, draw-out mechanical switches, mercury mechanical switches or door magnetic mechanical switches.

13. The remote public full-time anti-theft system as described in claim 12, wherein the communication module is a wireless data-transmitting module or a wireless transmitter.

14. The remote public full-time anti-theft system as described in claim 13, wherein the communication module is a GSM communication module, a GPRS communication module or a CDMA communication module.

15. The remote public full-time anti-theft system as described in claim 14, wherein the public data communication network is a GSM wireless data communication network, a GPRS wireless data communication network or a CDMA wireless data communication network.
